(19) United States
(12) Patent Application Publication
(10) Pub. No.: US 2010/0306384 A1
(43) Pub. Date: Dec. 2, 2010

(54) Multi-directional secure common data transport system

(76) Inventor: Keith Hayes, Coppell, TX (US)

Correspondence Address: CARSTENS & CAHOON, LLP, 13760 NOEL ROAD, SUITE 900, DALLAS, TX, 75240, US

(21) Appl. No.: 12/455,364

(22) Filed: Jun. 1, 2009

(51) Int. Cl. G06F 15/16

(52) U.S. Cl. 709/227

(57) ABSTRACT

The improved secure common data transport system features a transport bus, a system bus, and agents operating as software or a combination of hardware and software running on connected computers. Each agent contains various lower-level components for internal operations and modules that provide overall functionality. The agent interfaces with other agents via the system and transport busses. To communicate, Data, Control Logic, IO, and Security modules within an agent allow the agent to create a ticket that is formatted in XML and encrypted for security. Agents connect with other agents utilizing a Multi-IO Socket Engine that allows for true multi-directional communications socket connections. Multi-directional communication allows a first agent to communicate with a second agent simultaneously as the second agent is communicating with the first. The overall network configuration is determined by the types of socket connection the agents establish.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to computer network security devices and, more specifically, to a computer network security device that provides a secure common data transport for multi-directional communications in a service oriented architecture (SOA).

2. Description of Related Art including information disclosed under 37 CFR 1.97 and 1.98

Any given computer network, such as a LAN, WAN, or even the Internet, features a myriad of computing machines that are interconnected to allow them to communicate. These types of networks traditionally operate in a client/server arrangement that requires all messages between machines to pass through one or more central servers or routers. Such client/server communications are unidirectional, requiring a break in communications from one machine before another may initiate contact with it.

For example, consider the scenario in which a networked computer is hacked, causing the hacked computer to flood the network with data packets. Such a computer attack is relatively common, and is called a “denial of service” attack. Because the network is flooded with packets, no mechanism is available for a separate network controller to contact the hacked computer, via the network, to instruct it to cease transmissions. The network controller must instead wait for a pause in the hacked computer's transmissions—a pause which may never occur.

A further limitation in such client/server architecture is the limited access between connected computers. Until relatively recently, only files were available for access between computers. A networked computer may have a shared directory that allows another computer connected to the network to view and/or manipulate the files in the shared directory. However, such access was still limited to unidirectional client/server communications. Still, no mechanism was available to allow the remote computer to access the programs on the other computer.

Various protocols were subsequently developed to allow a networked computer to access and utilize programs running on remote computers. Protocols such as CORBA (Common Object Request Broker Architecture), DCOM (Distributed Component Object Model), and SOAP (Simple Object Access Protocol) were implemented based on the prevailing client/server network model.

CORBA is a software-based interface that allows software modules (i.e., “objects”) to communicate with one another no matter where they are located on a network. At runtime, a CORBA client makes a request to access a remote object via an intermediary—an Object Request Broker (“ORB”). The ORB acts as the server that subsequently passes the request to the desired object located on a different machine. Thus, the client/server architecture is maintained and the resulting communications between the client and the remote object are still unidirectional. DCOM is Microsoft's counterpart to CORBA, operating in essentially the same fashion but only in a Windows® environment.

SOAP is a protocol that uses XML messages for accessing remote services on a network. It is similar to both CORBA and DCOM distributed object systems, but is designed primarily for use over HTTP/HTTPS networks, such as the Internet. Still, because it works over the Internet, it also utilizes the same limiting client/server unidirectional communications as the other protocols.

U.S. Pat. No. 6,738,911 (the '911 patent), which was issued to Keith Hayes (the inventor of the invention claimed herein), discloses an earlier attempt at providing such secure communications. The '911 patent provides a method and apparatus for monitoring a computer network that initially obtains data from a log file associated with a device connected to the computer network. Individual items of data within the log file are tagged with XML codes, thereby forming a XML message. The device then forms a control header which is then appended to the XML message and sent to the collection server. Finally, the XML message is analyzed, thereby allowing the computer network to be monitored.

The '911 patent focuses primarily on network security in the sense that it monitors the log files of attached network devices, reformats the log file entries with XML tags, and gathers the files for analysis. Still, this technology is limiting because the entire process occurs with unidirectional data transfer.

FIG. 1 depicts a traditional client-server architecture utilizing present unidirectional data transfer protocols. As depicted, clients A (102), B (104), C (106), and D (108) are connected to a network via a server (110). Whenever client A (102) wishes to communicate with another client, such as client D (108), the data packet must travel from A to D via the server (110). In even larger networks, multiple servers (110) may be present which increases the number of “hops” between the source (A) and destination (D).

The client-server model falls short in that the client initiates all transactions. The server may send data to the client, but only as a response to a request for data by the client. One reasons for this is the randomness of the client sending its requests. If by chance both the server and client were to send requests at the same time, data corruption would occur. Both sides might successfully send their requests but the responses each would receive would be the other's request.

When utilized in a typical SOAP configuration, for example, each client may feature dedicated services. For example, client A (102) features service 1 (112); client B (104) features service 2 (114); client C (106) features service 3 (116); and client D (108) features service 4 (118). In a simple SOAP arrangement, client A (102) may access service 3 (116) over the network by making a request to the server intermediary (110) (known as the Object Request Broker). Still, unidirectional communications occur throughout.

Accordingly, a need exists for a secure method of communication in a distributed computer network architecture that is not limited to unidirectional client/server exchanges. The present invention satisfies these needs and others as shown in the detailed description that follows.

### BRIEF SUMMARY OF THE INVENTION

The present invention is a system and method for providing true multi-directional data communications between a plurality of networked computing devices. The system is comprised of agent modules operable on networked computing devices. Each agent module further comprises sub-modules that allow for the creation and management of socket connections with remote agents. Another sub-module provides a data ticket structure for the passing of system event and data transaction information between connected agent modules.

Each agent module features a control logic (CL) module for creation and management of ticket structures. The ticket structures include data tickets and system event tickets. A data ticket typically contains data that one agent module wishes to transmit to another, while a system event ticket contains information for reporting or triggering of a system event. The ticket structure allows for various fields to control, for example, the delayed transmission of the ticket, the repeated use of the ticket, and time synchronization of remotely connected agent modules.

The CL module may also utilize a ticketing queue to serially manage the sent and received ticket data. For example, all data tickets are queued for output. If a connection problem occurs, the data tickets remained queued until the problem is resolved and the data may be sent. Another queue may be utilized to store received data tickets, allowing the computing device (upon which the agent module is operating) sufficient time to process each ticket in the order received. Likewise, system event tickets may be sent and received utilizing the queues for management. For system events that occur repeatedly (such as a data logging function), it is possible to create one static system event ticket that remains in the agent's queue for repeat processing. In this manner, system resources are saved by not continuously recreating the same ticket structure.

Each agent module features an input output (IO) module that creates and maintains pools of various input and output socket types. These socket types include file stream, single-socket, multi-socket, and interprocess. An agent module running on a computing device may connect to another agent module by establishing both an inbound and an outbound socket with the remote agent, allowing simultaneous transmission and reception of data or system event tickets.

To maintain system integrity, the socket connections may be constantly monitored by the passing of beaconing messages. For example, a periodic beacon is transmitted from each agent to connected upstream agents. If this beaconing message is missed, a connection problem is assumed and corrective measures are taken. For example, in primary mode the system switches automatically to a backup socket connection upon failure of the primary socket connection. In primary-plus mode the system switches automatically to a backup socket connection upon failure of the primary-plus socket connection, but then switches back to the primary-plus socket connection once the problem is resolved.

These and other improvements will become apparent when the following detailed disclosure is read in light of the supplied drawings. This summary is not intended to limit the scope of the invention to any particular described embodiment or feature. It is merely intended to briefly describe some of the key features to allow a reader to quickly ascertain the subject matter of this disclosure. The scope of the invention is defined solely by the claims when read in light of the detailed disclosure.

### BRIEF DESCRIPTION OF THE SEVERAL VIEWS OF THE DRAWING(S)

The present invention will be more fully understood by reference to the following detailed description of the illustrative embodiments of the present invention when read in conjunction with the accompanying drawings, wherein:

FIG. 1 is a block diagram depicting a typical prior art client-server network configuration;

FIG. 2 is a block diagram depiction of the services framework architecture;

FIG. 3 is a depiction of a typical system agent;

FIG. 4 is a depiction of a typical system ticket, highlighting the available data fields;

FIG. 5 is a block diagram depiction of the basic Multi 10 Socket Engine (MIOSE);

FIG. 6 is a block diagram depiction of the Socket Control Matrix;

FIG. 7 is depiction of an agent having two Single-Socket Inbound connections, three Multi-Socket Inbound servers, two file streams, and three Single-Socket outbound connections with corresponding queues;

FIG. 8 depicts a client-server model configuration utilizing system agents;

FIG. 9 depicts a multi-directional model configuration utilizing system agents;

FIG. 10 depicts a proxy model configuration utilizing system agents;

FIG. 11 depicts a hierarchical model configuration utilizing system agents; and

FIG. 12 depicts a cluster model configuration utilizing system agents.

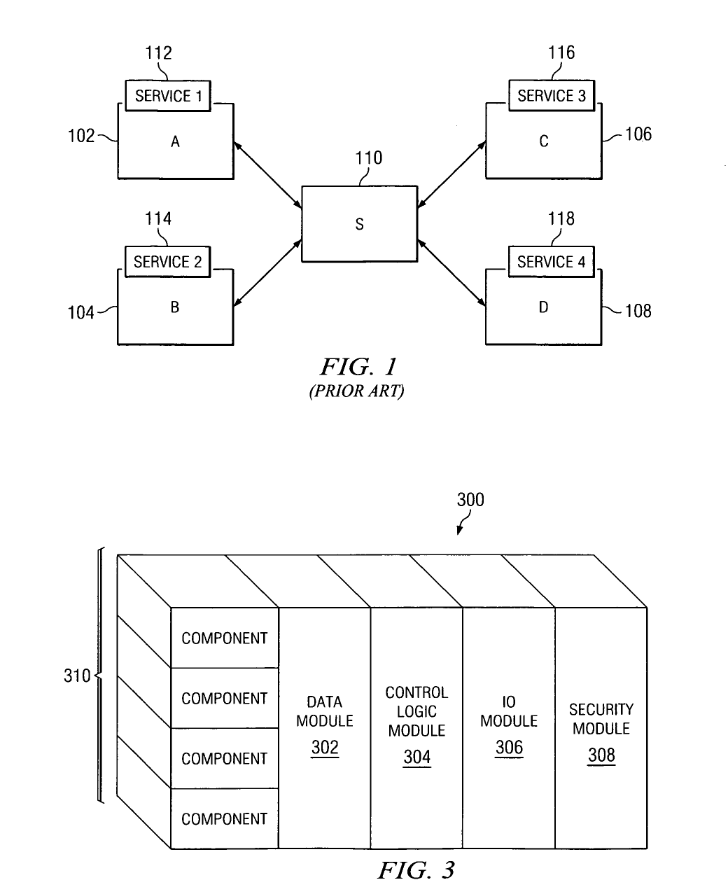

The above figures are provided for the purpose of illustration and description only, and are not intended to define the limits of the disclosed invention. Use of the same reference number in multiple figures is intended to designate the same or similar parts. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

As mentioned previously, the present inventor received an earlier patent (U.S. Pat. No. 6,738,911; the “'911 patent”) for technology related to XML formatting of communications data that is utilized with the present invention. Accordingly, the disclosure of the '911 patent is hereby incorporated by reference in its entirety in the present disclosure.

The network configuration as utilized by the present invention may be a personal area network (PAN), local area network (LAN), metropolitan area network (MAN), wide area network (WAN), Internet, or any such combination. Further, the network may be comprised of any number or combination of interconnected devices, such as servers, personal computers (PCs), work stations, relays, routers, network intrusion detection devices, or the like, that are capable of communication over the network. Further still, the network may incorporate Ethernet, fiber, and/or wireless connections between devices and network segments.

The method steps of the present invention may be implemented in hardware, software, or a suitable combination thereof, and may comprise one or more software or hardware systems operating on a digital signal processing or other suitable computer processing platform.

As used herein, the term “hardware” includes any combination of discrete components, integrated circuits, microprocessors, controllers, microcontrollers, application-specific integrated circuits (ASIC), electronic data processors, computers, field programmable gate arrays (FPGA) or other suitable hardware capable of executing program instructions and capable of interfacing with a computer network.

As used herein, “software” can include one or more objects, agents, threads, lines of code, subroutines, separate software applications, two or more lines of code or other suitable software structures operating in two or more software applications or on two or more processors, or other suitable hardware structures.

The system in a preferred embodiment is comprised of agent software running on multiple interconnected computer systems. Each agent comprises at least one primary module, and provides a gateway between internal and external components as well as other agents connected to the system.

Services Framework

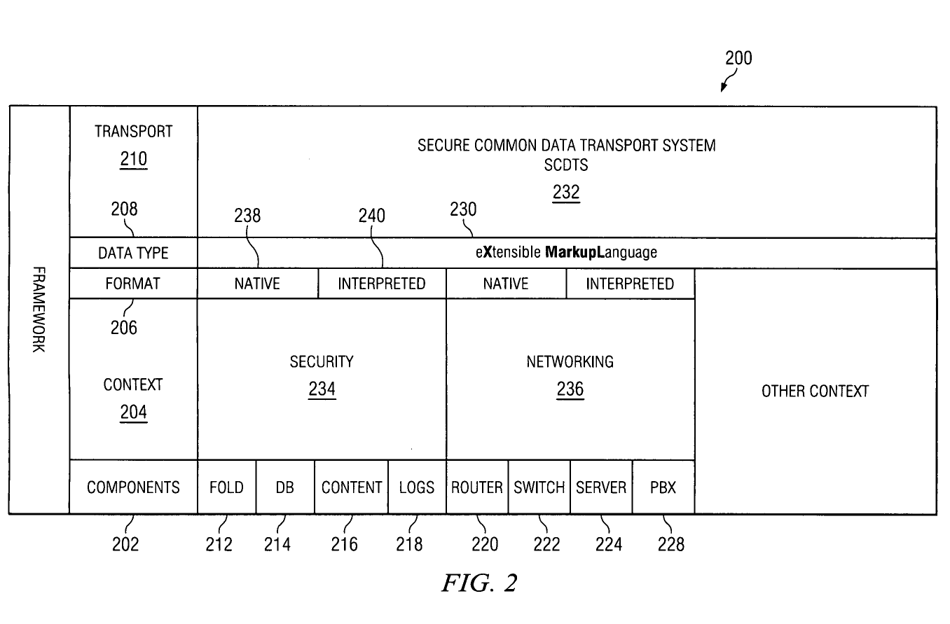

FIG. 2 depicts the services framework in which the present invention operates. The services framework outlines a systematic approach designed to exchange data between like and dislike components. It establishes a common interface and management methodology for all Intra-Context or Inter-Context components to communicate in a secure manner.

Within the framework (200) are a variety of layers. The first is the component layer (202). The component layer (202) comprises the devices that establish the context (204) in which a service operates. For example, the figure depicts two contexts: security (234) and networking (236). Components such as firewalls (212), intrusion detection systems (214), content security devices (216), and system and application logs (218) may combine to form a security context (234). Likewise, routers (220), switches (222), servers (224), and PBXs (228) may combine to form a networking context (236). It is important to note that such components may appear in more than one context, and that it is the overall combination of components and their ultimate use that determines the operating context.

The next layer is the context layer (204). A context (204) can be described as an area of concentration of a specific technology. The framework has different context modules, which are specific to the type of services needed. A typical security context (234) is designed to transport configuration data, logs, rule sets, signatures, patches, alerts, etc. between security related components. The networking context (236) is designed to facilitate the exchange of packets of data between services on the network. One skilled in the art will appreciate that other context modules may be created—such as VOIP or network performance monitoring modules—and incorporated as described without exceeding the scope of the present invention.

The next layer is the format layer (206). The format (206) describes the method in which the data is transposed in to the Common Data Type. If a context has the capability to format data in a common format (such as XML), it is said to have a native format (238). If the context still uses a proprietary format that must be converted to a common format, it is said to have an interpreted format (240). It is also possible for a context to have both common and interpreted capabilities.

The next layer is the data type layer (208). The data type (208) depicted utilizes extensible Markup Language (XML) open standard. However, other data encapsulation methods may be used without straying from the inventive concept. Using XML meta-language allows the system to transmit its integrated schema (with instructions on how to interpret, transport, format data and commands being transmitted) between the various agents in the system. This allows the agents to properly interpret any XML data packet that may arrive. Adopting formatting continuity affords an extremely flexible system that can accommodate additional modules as necessary without major modification to basic network and system infrastructure.

The next layer is the transport layer (210). The transport layer (210) provides the means for transporting context data between other contexts. Component data in a common format is useless unless it can be transported to other components and potentially stored and managed from a central location. The present embodiment provides a secure means of data transport for this transport mechanism.

Secure Common Data Transport System

The secure common data transport system (SCDTS) of the present embodiment provides a system to securely transport common data from component to component by providing a novel data interchange. The system is comprised of agent software running on multiple computer systems interconnected with any network architecture. This agent software consists of lines of code written in C, C++, C#, or any software development language capable of creating machine code necessary to provide the desired functionality. One or more lines of the agent software may be performed in programmable hardware as well, such as ASICS, PALS, or the like. Thus, agent functionality may be achieved through a combination of stored program and programmable logic devices.

FIG. 3 depicts an agent (300) as utilized in the present embodiment. In the figure, it is shown that the agent (300) comprises four primary modules: Data (302); Control Logic (304); Input/Output (IO) (306); and Security (308). One skilled in the art will appreciate that other modules providing specialized utilities may be implemented and utilized depending on the required functionality and are within the scope of the present invention.

Components (310) provide input and output processing for the modules (302-308) and include external and internal based functionality. The internal components provide functionality to the four primary modules (302-308) and may be used by all other components. This functionality includes, but is not limited to, utilities such as file transfer; remote command execution; agent status; and web and command line interfaces. External component functionality includes, but is not limited to, generation and receipt of data. This includes applications such as Web servers, databases, firewalls, personal digital assistants (PDA's), and the like.

The data module (302) in the present embodiment converts data to and from the selected common format that is received or sent to the components. Although the present embodiment utilizes XML, the data module (302) can maintain any number of different conversion formats. Standard XML APIs like SAX, DOM, and XSLT may be utilized to transform and manipulate the XML documents. The module also checks XML integrity with document type definition validation. Below is an example conversion of an event from a native Linux syslog format to XML:
Pre Formatted:
   Oct 2711:20:12 Polaris sshd[1126]: fatal: Did not receive ident
Post Formatted:

```
<LINUXSL>
    <LOG>
    <DATE>Oct27</DATE>
    <TIME>II:20:12</TIME>
    <HOST>Polaris</ HOST>
    <PROCESS>sshd[1126]: </ PROCESS>
    <MESSAGE>fatal: Did not receive ident string</MESSAGE>
    </LOG>
</LINUXSL>
```

The Control Logic module (306) provides mechanisms for routing the common data between agents. The present embodiment utilizes a peer-to-peer architecture supporting: data relaying; group updating; path redundancy; logical grouping; heartbeat functionality; time synchronization; remote execution; file transfer, and the like.

The Control Logic module (306) in this embodiment is implemented at layer 5, the session layer, of the OSI model. This layer has traditionally been bundled in with layer 6 (the presentation layer) and layer 7 (the application layer). Such integration is beneficial because it is independent from the lower layer protocols allowing multiple options for encryption; it is IP stack independent; it directly connects to presentation layer; it interfaces with layer 4 (the transmission layer), which is also used to create network and inter-process communications; and it can utilize TCP for reliable connectivity and security or UDP for raw speed. Such design follows technologies developed for routing protocols for layer 3. However routers are ultimately responsible for physical connectivity, where as the Control Logic module is concerned with logical connectivity.

The Control Logic module (306) is also built around a ticketing queue system (TQS) and the transmission command language (TCL) used for system communications and data exchange. Tickets are data structures that contain the necessary information to transmit or store, data, system information, commands, agent updates, or any other type of information for one to multiple agents in a distributed architecture.

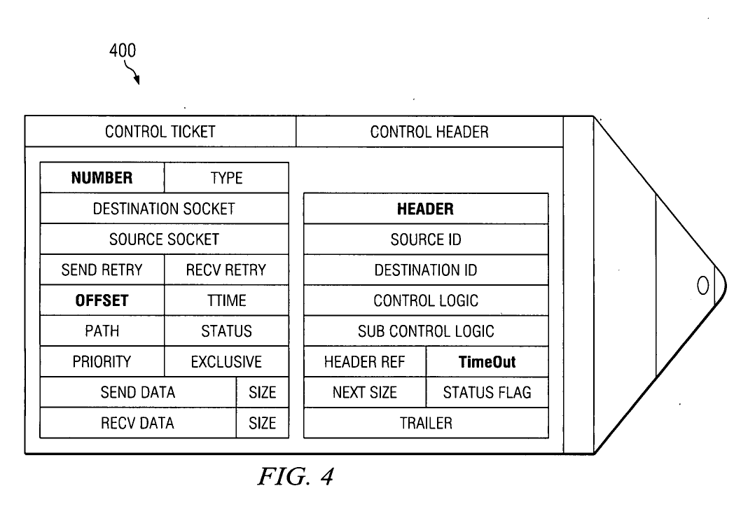

FIG. 4 depicts a ticket (400) that is created by the Control Logic module (306). In the present embodiment, tickets are constructed by combining two subcomponents, the Control Ticket and the Control Header. The Control Header contains information that describes how, where and to which component the ticket should be transmitted. This header is always the first data transmitted in between agents. In the event this data is misaligned, invalid, or out of sequence, it will be disregarded and reported as a communication error. Multiple errors of this type may result in the ticket being discarded or termination of the connection. This provides an additional level of transmission validation.

The Control Header fields include Header, Source ID (SID), and Destination ID (DID). The Header is an alphanumeric sequence used to pad the beginning of the control header. This alphanumeric field can be implemented to utilize Public Key Infrastructure (PKI) identification keys to provide added security where the underlying transport is left unmodified. The SID provides the device ID of the source agent initiating the data transmission. The DID is the ultimate destination of the ticket, and can be represented as a number of different variables. Destination types include a Device ID, Group ID, and Entity ID. The present embodiment uses a unique transmission control language (TCL) comprised of two fields that determine how and where to transmit tickets.

The Control Header also includes a field for Control Logic. This field is the primary field used to determine the series of transmissions necessary to transport the ticket. The TCL commands utilized for Control logic include, but are not limited to, the following:

| | |
|---|---|
| CLOGIC_SEND | Send ticket with data to peer |
| CLOGIC_RECV | Send ticket with request for data to peer |
| CLOGIC_EXCH | Send ticket with data & request for data to peer |
| CLOGIC_RELAY | Send ticket with data & request to relay to peer |
| CLOGIC_BEACON | Send ticket with notification of connectivity loss |
| CLOGIC_ECHO | Send ticket with request to send back |
| CLOGIC_ERROR | Send ticket with notification of error |
| CLOGIC_BCAST | Send ticket with to all peers belonging to local |
| | peers group |
| CLOGIC_MCAST | Send ticket with to connected peers |
| CLOGIC_DONE | Send ticket to end previous transmission |

The next field in the Control Header is the Sub Control Logic field. The Sub Control Logic field defines the specific components to send and process the data. Processing of Sub Control Logic can also be performed before data transmission. The number of sub logic definitions is unlimited. The TCL commands utilized by the present embodiment for Sub Control logic include, but are not limited to, the following:

| | |
|---|---|
| S_CONTROL_NULL | No Processing is performed |
| S_CONTROL_EVENTDATA | Contains event data |
| S_CONTROL_MESSAGE | Contains a system message |
| S_CONTROL_AGENTSTATUS | Used to obtain agent information |
| S_CONTROL_EXECUTE | Used to execute remote commands |
| | (requires special privileges) |
| S_CONTROL_IDENT | Used to exchange peer identification |
| S_CONTROL_TIMESYNC | Used to sync time in between peers |
| S_CONTROL_RESET_CONN | Request a connection reset |
| S_CONTROL_RESET_LINK | Request a link reset |
| S_CONTROL_RESPONSE | Contains a response to a previous |
| | request |
| S_CONTROL_FILEXFER | Transfer files to and from agents |
| S_CONTROL_TOKENREQ | Makes a formal requests for the |
| | communication token |

In the present embodiment, each agent is required to send a CONTROL_ECHO ticket to it's upstream neighbor(s) to insure the communication lines are working. When the Control Logic receives this type of command it simply responds back a CONTROL_DONE. When Control Logic receives a CONTROL_DONE it knows its previous transmission was received and moves on to the next. This establishes the framework for an unlimited variety of transactions. By modifying the tickets Control Logic and Sub Control Logic fields, distributing and processing common data has unlimited possibilities. The system performs built in checks for validation to prevent unwanted control combinations.

The Control Header also includes a Header Reference field. This field identifies transmissions and sequences to the receiving peer. The Control Header contains information that describes how, where and to which component the ticket should be transmitted. This header is always the first data transmitted in between agents. In the event this data is misaligned, invalid, or out of sequence, it will be disregarded and reported as a communication error. Multiple errors of this type may result in the ticket being discarded or termination of the connection, providing an additional level of transmission validation.

The next field in the Control Header is the Timeout field. This field is used to prevent agents from blocking certain IO system calls. If data is not read or written in this time period the transmission results in a communication error and is disregarded. This also helps to prevent certain types of denial of service attacks.

The next field in the Control Header is the Next Size field. This field informs the Control Logic module (306) of the size of the data packet being transmitted. By expecting a specific size, the Control Logic module can keep track of how many bytes was already received and timeout the transmission if the entire payload is not received in a timely manner.

The next field in the Control Header is the Status Flag. The Status Flag is set by peers in the network to maintain the granular state of the transmission.

The next field in the Control Header is the Trailer field. This field provides an alphanumeric sequence that is used to pad the end of the control header. This alphanumeric field can be implemented to utilize Public Key Infrastructure (PKI) identification keys to provide added security where the underlying transport is left unmodified.

The ticket (400) Control Ticket subcomponent features additional fields. The first is the Ticket Number. This number is assigned to a ticket before it is sent into the queue. It has local significance only, and may also be used as a statistical counter.

The next field in the Control Ticket is the Ticket Type. This field is used to categorize tickets. By categorizing tickets (400), the system may more easily select tickets by groupings.

The next field in the Control Ticket is the Receive Retries field. This field is an indication of the number of times the Control Logic module (304) will attempt a low level read before the ticket (400) is discarded. This functionality adds extra protection against invalid tickets.

The next field in the Control Ticket is the Send Retries field. This field is an indication of the number of times the Control Logic module (304) will attempt a low level write before ticket (400) is discarded. This functionality adds extra protection against malicious activity.

The next field in the Control Ticket is the Offset field. This field enables time synchronization between peers separated by great distances. For example, two peers located on opposite sides of the globe will encounter a relatively long latency during communications.

The next field in the Control Ticket is the TTime field. This field indicates the time that the ticket (400) will be transmitted. Its purpose is to allow immediate or future transmissions of data.

The next field in the Control Ticket is the Path field. This field enables a discovery path by allowing each peer that processes the ticket to append its device ID. This can be used to provide trace-back functionality to tickets (400).

The next field in the Control Ticket is the Status field. This field identifies a ticket's (400) transmission status and is used to unload tickets from the queues.

The next field in the Control Ticket is the Priority field. This field allows prioritization of tickets (400). Tickets having a higher priority are sent before lower priority tickets.

The next field in the Control Ticket is the Exclusive field. This field is used to determine if multiple tickets (400) of the same type can exist in the same queue.

The next field in the Control Ticket is the Send Data field. This field provides the location of the data that is to be sent. This is also accompanied by a Size to Send field, which provides the size of the data that is to be sent.

The next field in the Control Ticket is the Receive Data field. This field provides the location wherein the data will be temporarily stored. This is also accompanied by a Size to Receive field, which provides the size of the data that will be received.

Queuing of tickets (400) is the responsibility of the IO module. However, the Control Logic module in the present embodiment creates tickets and inserts them into the appropriate queues. Queuing is added as a data integrity tool for the preservation of tickets in the event of connectivity problems and to store tickets that are destined for transmission at a later time. The two types of queues are system and data, with the system queue handling system event tickets and the data queue handling data transaction tickets.

In the present embodiment there is one system queue per agent (300). Events that occur often or at a later time are stored in this queue. This queue also stores tickets (400) for specific internal system events such as maintenance, agent communication, and the like. Regularly scheduled events are stored in the system queue permanently, because the data in such tickets are static making it more efficient to reuse them rather than creating and destroying them after each use. These scheduled events will be processed based off their TTime.

Data tickets are temporarily stored in the data queue. Data transactions can be received from other agents, generated by file streams, or created by an operator connected via a socket connection (SSI). Actual queuing is a function of the Single Socket Outbound connection of the IO module, which is discussed below.

IO Module

The IO (Input Output) module in its present embodiment provides a dynamic socket creation and monitoring engine responsible for network and inter-process communications, file stream, and general process IO routines. The IO module and the Control Logic module together provide a session-level switching engine used for the interconnectivity of networked peers.

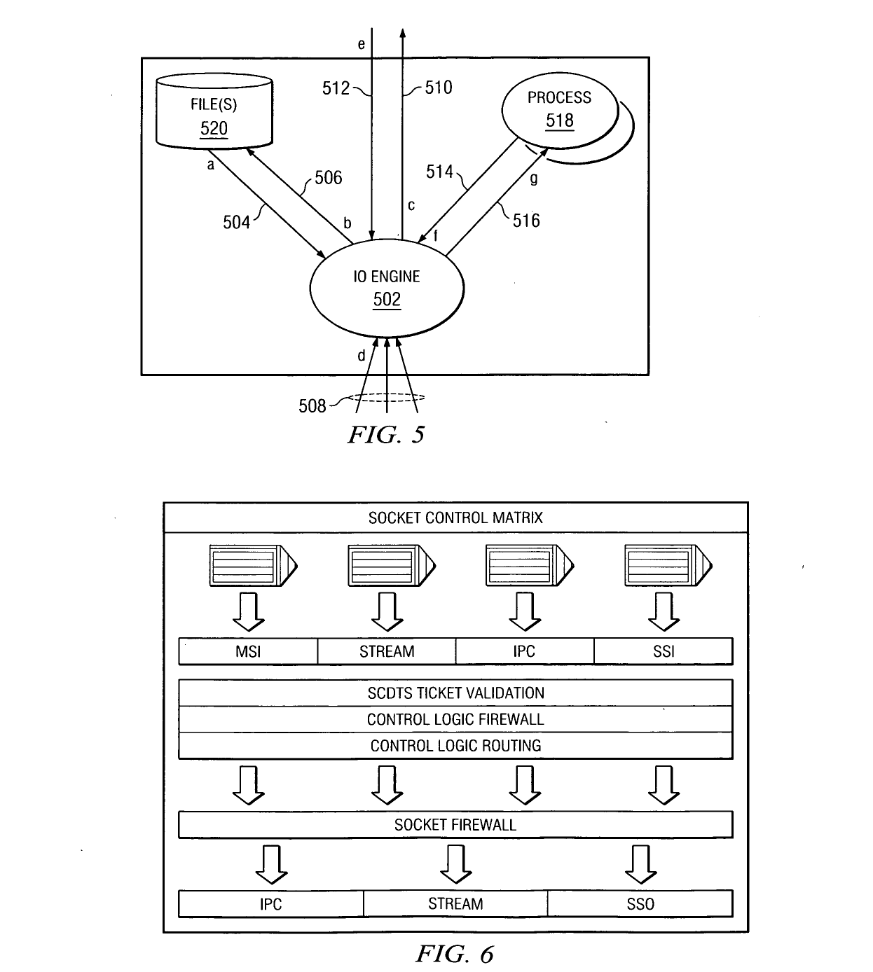

FIG. 5 depicts the types of IO connections that can be achieved using the Multi IO Socket Engine (MIOSE). The connections include: inbound file stream (504); outbound file stream (506); single-socket-outbound (510); multi-socket-inbound (508); single-socket-inbound (512); inbound interprocess (514); and outbound interprocess (516). In yet another embodiment, the MIOSE provides a subset of the aforementioned connection types.

In general, references herein to “input” or “inbound” connections refers to connections initiated to a particular agent (300), while “output” or “outbound” connections refers to connections initiated by the particular agent.

The MIOSE in the present embodiment performs the following tasks:
read configuration file and dynamically determine what types of connections the engine must support;
validate the configuration entries syntax and technical correctness;
load each different type into specific grouped entry table;
initialize each entry and update the entry tables;
provide ongoing monitoring of each connection for data exchange and errors;
provide continuous connectivity by keeping track of each connection's state;
provide heartbeat functionality, high availability and redundancy;
add, remove or change entry tables on-the-fly;
de-initialize entries;
provide statistics per entry;
provide queuing mechanism for congestion or loss of connectivity;
provide multi-load-queuing for data duplication. (a.k.a. “split data center or data replication”);
provide connection verification system to prevent unauthorized connections, connection high-jacking and DOS attempts;
provide non-blocking connectivity;
create, track and teardown transmission links; and
manage link data transmissions.

The MIOSE inbound file stream (504) is quite common and its uses are essentially endless. The MIOSE provides monitoring, buffered input, and formatted output on these file streams. Inbound file streams (504) are most commonly used to monitor log files from operating systems and applications. When used in this fashion, the received data is typically forwarded to the Data Module to format a native log data to a common format such as XML or the like.

During operation, the inbound stream (504) monitors for new stream inputs and for any errors reported from the streams. Examples of errors that would generate an alert include deleting or moving the file inactivity for a pre-determined time, and file system attributes changes.

In the present embodiment, the inbound file stream (504) supports whatever file types exist on the underlying operating system. For example, a STREAM1 file format supports data preformatted to support common data (for example, XML files), delineated data formats (such as comma separated values), and interpreted formats using regular expressions for extraction. A STREAM2 file format supports data that has been formatted to include all of the available fields in a ticket (400) as described above.

With the inbound file stream (504), stream configuration is controlled by a template. An example of such a template is:

```
# Linux; syslog module
<LINUXSL>
    <CONFIG>
        <NAME>LINUXSL</NAME>
        <TYPE>STREAM</TYPE>
        <DELIM></DELIM>
        <GROUP>POLARIS</GROUP>
        <INPUT>tail -f -n 1 /var/log/messages </INPUT>
        <OUTPUT>POLARIS</OUTPUT>
    </CONFIG>
    <LOG>
        <DATE> ([A- Z] [a-z] (1 , 2}) ? [0 - 9] {1, 2 }</DATE>
        <TIME> (O? [0-9] 11 [0 - 9] 12 [0 - 3]): [0-5] [0 - 9]</TIME>
        <HOST> ( [a - zA-Z . -]+ )</HOST>
        <PROCESS> [a-zA-ZO-9 ][a-zA-ZO-9]*([[0-9]*]:)
        </PROCESS>
        <MESSAGE>([A : *])+$</MESSAGE>
    </LOG>
</LINUXSL>
```

This instructs the MIOSE to monitor the file named /var/log/messages. Within the <LOG> elements are instructions to extract the correct information out of the stream data.

The MIOSE outbound file stream (506) stores tickets (400) from handling queues to hard disks. STREAM2 format is primarily used. However, components can be written to support any output format. Examples of use include, but are not limited to, dumping queues for the preservation of system memory and preservation of data due to connectivity problems, system reboots, or agent (300) deactivation. Such streams are numerous and are also monitored for errors.

The MIOSE single-socket-outbound (SSO) (510) file stream connection in the present embodiment is the workhorse of the MIOSE model. The primary functionality includes, but is not limited to, providing connectivity to networked peers. An SSO connection is created from the configuration file with a pre-determined remote IP address and port number. In this embodiment, all SSO connections are TCP based to provide a connection-oriented socket. Assuming that the connection was granted by the peer, the socket information is stored in the SSO connection table and waiting for insertion into the main loop.

The MIOSE of the present embodiment monitors each SSO (510) connections state. The different states include, but are not limited to, the following:

| | |
|---|---|
| OFFLINE | Connection is OFFLINE |
| ONLINE | Connection is ONLINE (Healthy Connection) |
| BEACON | Connection has been disconnected and is |
| | trying to reconnect (connection down) |
| BACKEDUP_BEACON | Connection has been backed up but still |
| | trying to re-establish its original connection |
| BACKEDUP_OFFLINE | Connection has been backed up with |
| | original connection set to OFFLINE |

In the present embodiment of the MIOSE, beaconing is common to all types of SSO (510) connections. Beaconing provides a resilient connection to upstream neighbors, and is essentially designed as a “call for help” in the event of system connectivity loss. The beacon is based off of the following information:

| | |
|---|---|
| Beacon Count | How many times it tries to reconnect |
| Beacon Interval | How often the Beacon Count occurs |

(Beacon Count × Beacon Interval) = Beacon Duration

If Beacon Duration expires without a reconnection then the MIOSE will attempt a backup connection.

SSO Connection Modes

The three different SSO (510) connection modes utilized in this embodiment are Primary, Primary Plus, and Backup. Each SSO connection entry is labeled with a mode specifier entry in the global configuration file. Each SSO connections importance and functionality is dependent upon the mode. Backup connection are loaded in to the entry table but are not initialized until called upon by the MIOSE to backup a failed Primary or Primary Plus connection.

Primary and Primary Plus connections are initialized at the start of MIOSE initialization. The difference becomes apparent in the event of a SSO connection failure. With a Primary SSO connection, if connectivity is lost a backup connection is automatically initialized. Later, if the same Primary connection becomes available again, the MIOSE will still continue to utilize the Backup connection and set the original Primary connection state to BACKEDUP_OFFLINE.

With a Primary Plus SSO connection, if connectivity is lost a Backup connection is automatically initialized. Later, if the same Primary Plus connection becomes available again, the MIOSE will set the Backup connection to OFFLINE and reestablish the original Primary Plus connection. In the event the Primary Plus connection cannot be restored, the Primary Plus connections state is set to BACKEDUP_BEACON and the MIOSE will continuously try to reconnect.

Beaconing is dependent on the SSO connection (510) mode, and functions as follows:

| Mode | Status | Group Status | Action |
|---|---|---|---|
| Primary Plus | OFFLINE | Disabled | Beacon |
| Primary Plus | ONLINE | Disabled | None |
| Primary | BEACON | Disabled | Beacon |
| Primary | ONLINE | Disabled | None |
| Primary | BACKEDUP_OFFLINE | Disabled | None |
| Backup | OFFLINE | Disabled | None |
| Backup | ONLINE | Disabled | None |

SSO Queuing

As mentioned previously, queuing also serves as a data integrity tool for the preservation of tickets (400) in the event of connectivity problems. This functionality is applied by the present embodiment at the point before transmitting these tickets to the connected peers. The most logical point for this to occur is the outbound file stream connection (506) or the SSO connection (510).

Multiple SSO (510) connections are supported by each agent. Each SSO (510) connection has a dynamically created queue used to preserve tickets in the event that a connection is not available. For example, if a connection to an upstream peer (labeled SS01) is terminated, the queue attached to the SS01 entry table will be loaded with any tickets remaining to be sent from that connection. Once the connection is brought back online, the queue is retransmitted upstream and then unloaded to preserve memory. Common queue behavior can be shown by the following table:

| Mode | Status | Criteria | Action |
|---|---|---|---|
| Any | OFFLINE | Any | None |
| Any | ONLINE | Matched | Queue |
| Any | ONLINE | No Match | None |
| Any | BEACON | Matched | Queue |
| Any | BEACON | No Match | None |
| Primary Plus | BACKEDUP_BEACON | Any | None |
| Primary | BACKEDUP_OFFLINE | Any | None |

Communication Error Tracking

The MIOSE tracks communications for errors and acts accordingly. For example, if the agent accepting a connection from its downstream neighbors is shutdown, the IP stack of the server agent would send FIN and RESET packets shutting down the TCP connection. Upon receiving these packets the MIOSE of the client agent terminates the SSO connection and labels the connection status as BEACON. The MIOSE then tries to reconnect to the SSO connection for “Beacon Count” number of times at an interval of “Beacon Interval”. If Beacon Count=5 and Beacon Interval=10 then the MIOSE will try to reconnect to the upstream server every 10 seconds for 50 (5×10) seconds before trying to establish backup connection. Depending on the type of SSO connection that failed and what types of SSO connections were available determines which steps are taken to obtain a backup.

For another example, if there are communication errors in between the two agents, (such as from a cable failure, network adapter failure, operating system crash, agent problem, or any such reason), the MIOSE tracks the error and in a pre-determined number of errors, places itself into beacon mode.

The following is a template example for creating an SSO (510) configuration:

```
# Single Socket Out template
<SSO1>
    <CONFIG>
        <NAME>SSO1</NAME>
        <TYPE>SSO</TYPE>
        <GROUP>POLARIS</GROUP>
        <MODE>PRIMARY_PLUS</MODE>
        <BEACONCOUNT>5</BEACONCOUNT>
        <REMOTEIP>150.100.30.155</REMOTEIP>
        <REMOTEPORT>10101</REMOTEPORT>
        <INPUT>ANY</INPUT>
    </CONFIG>
</SSO1>
```

This instructs the MIOSE to establish a single socket connection to 150.100.30.155 on port 10101. The mode is set to Primary Plus and belongs in the group called POLARIS.

Multi Socket Inbound

The MIOSE Multi-Socket-Inbound (MSI) (508) file stream connections are server based and receive connections from other agent's (300) SSO (510) connections. This is the receiving end of a connection between two agents (300). MSI supports a single socket with a pre-defined number on inbound connections. Each MSI connection server keeps track of the peers connected to it checking for data, errors, and stream inactivity. The data received from the peers are formatted as tickets (400).

With an MSI (508) connection, the server checks for format and validation of each ticket. In the event of a timeout, error, or invalid data sequence the connection is terminated and cleared from the MSI entry table. The requirements for ticket validation are strict to prevent the insertion of corrupt or malicious data from entering the SCOTS network.

Each MSI (508) server can be individually configured to accept a maximum number of clients, inactivity timers, IP address and port number. S_CONTROL_IDENT tickets are exchanged for validation of connectivity including agent revision, Entity ID, Group ID, and Device ID.

MSI (508) and SSO (510) connections follow the client-server module of computer networking. Providing a secondary connection from the server back to the client significantly enhances overall functionality. This configuration is the basis for the peer to peer architecture of the present invention.

The following is a template example for creating an MIS (508) configuration:

```
# Multi Socket Out templates
<MSI1>
    <CONFIG>
        <NAME>MSI 1</NAME>
        <TYPE >MSI </TYPE>
        <GROUP >DOWNSTREAM</GROUP>
        <MODE>PRIMARY</MODE>
        <MAXNUMCLIENTS >128</MAXNUMCLIENTS>
        <CLIENTTIMEOUT>60< /CLIENTTIMEOUT>
        <OUTPUT>SSO1</OUTPUT>
        <LOCALIP>150.100.30.155</LOCALIP>
        <LOCALPORT>10201</LOCALPORT>
    </CONFIG>
</MSI1>
```

This configuration template instructs the MIOSE to bind a connection to 150.100.30.155 on port 10201 for 128 clients. The timeout is set to 60 seconds.

Single Socket Inbound

With the MIOSE, Single-Socket-Inbound (SSI) (512) connections—like MSI (508) connections—act as servers to handle inbound connectivity. Unlike MSI connections that require persistent connectivity, SSI (512) connections are created to handle specific types of non-persistent user interaction. Examples of specific types of non-persistent interaction include, but are not limited to: Command Line Interfaces; Web Based Interfaces; Graphical User Interfaces; Stream2 interfaces; and Statistics and Monitoring of the SCOTS system. Any number of SSI (512) connections can be created since they are just a special use component.

Inter-Process Communications

With the present embodiment of the MIOSE, both Inbound Interprocess (IIP) and Outbound Interprocess (OIP) connections allow for communication with other processes running on the same machine as the respective agent (300). This provides the MIOSE greater flexibility to communicate with other software programs on a more specific basis. Well-written applications provide application program interfaces (API's) to allow third party interaction.

The Socket Control Matrix

The Control Logic and IO modules work together to provide a flexible and powerful communication exchange system called the Socket Control Matrix (SCM). FIG. 6 illustrates the SCM in the present embodiment.

Referring to FIG. 6, tickets (400) are created containing event data, commands, and files and are sent in to the specific socket type for initial processing by the MIOSE. The IO module passes the ticket to the Control logic Module where the ticket's fields are validated prior to being sent to the Control Logic firewall.

Control Logic Firewall

When interconnecting various components in the network, it may be necessary to control the exchange of data. System agents (300) in the present embodiment have a multi-level firewall capability, one of which operates within the Control Logic module. The Control Logic Firewall (CLF) uses common functionality as found with network level firewalls except it forwards and filters based on the contents within the ticket (400). A fully customizable Rule Base is used to control tickets destined to local or remote peers. The Rule Base is comprised of individual rules that include, but are not limited to, the following elements:

Control Logic Firewall Rule Elements

| | |
|---|---|
| Source | Originating agent sending ticket |
| Destination | Recipient(s) of ticket |
| Direction | |
| Control Logic | The Control Logic allowed for transmission |
| Sub Control Logic | The Sub Control Logic allowed for transmission |
| Security | Not Implemented Yet |
| Priority | Allowing similar rules to have different priorities |
| Access Time | The system date and time the rule applies |
| Log Type | How to log the event |

Control Logic Routing

As shown above, the destination of the ticket is contained in each control header of each ticket (400). The destination of each ticket is predetermined by its originator. The destination can be any valid ID given to an agent or group of agents.

Agent Identity

Upon successful initialization, system agents are configured with the following identifiers: Device ID, Group ID, Entity ID, Virtual ID, and Module ID.

The Device ID (DID) describes a generic ID used to represent the device the agent resides on. In this embodiment the ID is similar to the IP address and MAC address in the lower layer protocols. It is important to note once again that multiple instances of the agent can reside on a single hardware device.

The Group ID (GID) allows for the classification of DID's. This aids the system in ticket routing, broadcasts and multicasts transmissions.

The Entity ID (EID) expands the classification process by allowing the grouping of GID's.

The Virtual ID (VID) describes a specific IO connection (socket) attached to the agent. This is typically a SSO (510) connection, and is used to aid in routing and path creation.

The Module ID (MID) is used to identify the components that generate and process the common data. Example modules include common data parsers, API's, database connectors, and expert systems. By including the specific components available from each agent, it is possible to further categorize ticket destinations and provide remote services to agents with limited capabilities. Multiple instances of any module can exist within each agent.

Agent Connection Table

The Agent Connection Table (ACT) contains a list of local and remotely connected agent's MID, EID, GID, VID used to connect, and the available components MID's. From this table agents (300) are able to determine how and where to process tickets. The ACT includes associated routing information that informs agents how to transmit tickets to other agents.

Based off the “Laws of Ticket Exchange” in the table below, the MIOSE will determine the correct location to search for the ultimate ticket destination. When the ultimate destination is known, the appropriate SSO (510) connection queue or queues are loaded. Assuming there are no connectivity issues, the MIOSE dumps SSO (510) connection queues and then clears out the queue.

| Search Source | Control Logic | Destination | Action |
|---|---|---|---|
| Local Identity | CONTROL_SEND | <DID> | Process Ticket( ) |
| Local Identity | CONTROL_SEND | <EID> or <GID> | Process Ticket( ) |
| | | | MultiLoadQueue( ) |
| Local Identity | CONTROL_SEND | Unknown | Ignore |
| Local Identity | CONTROL_RELAY | <DID> | Ignore |
| | | | Downstream Neighbors |
| | | | should have known |
| SSO_TABLE | CONTROL_RELAY | <EID><GID> | Search all |
| | | | sso_conn_entries for |
| | | | match, then multi-load |
| | | | based on laws of queuing. |
| | | | It can be tweaked to include |
| | | | all and or OFFLINE |
| | | | sso_cons. |
| SSO_TABLE | CONTROL_RELAY | Unknown | Search all |
| | | | sso_conn_entries for |
| | | | match, then multi-load |
| | | | based on laws of queuing. |
| | | | It can be tweaked to include |
| | | | all and or OFFLINE |
| | | | sso_cons. |

In the event the connection queue(s) are not unloaded, valuable memory will be used up. The MIOSE has a pre-determined limit which will cause the tickets (400) to be dumped to a file on the local file system. After connection is re-established the file will be read back in to the queue, removed form the file system, and then dumped and unloaded in the original manner. The latency of the queuing architecture is minimal and represents a store and forward approach.

How the MIOSE determines which tickets are queued is illustrated in the following table:

| Mode | Status | Criteria | Action |
|---|---|---|---|
| Any | OFFLINE | Any | None |
| Any | ONLINE | Matched | Queue |
| Any | ONLINE | No Match | None |
| Any | BEACON | Matched | Queue |
| Any | BEACON | No Match | None |
| Primary Plus | BACKEDUP_BEACON | Any | None |
| Primary | BACKEDUP_OFFLINE | Any | None |

Socket Firewall

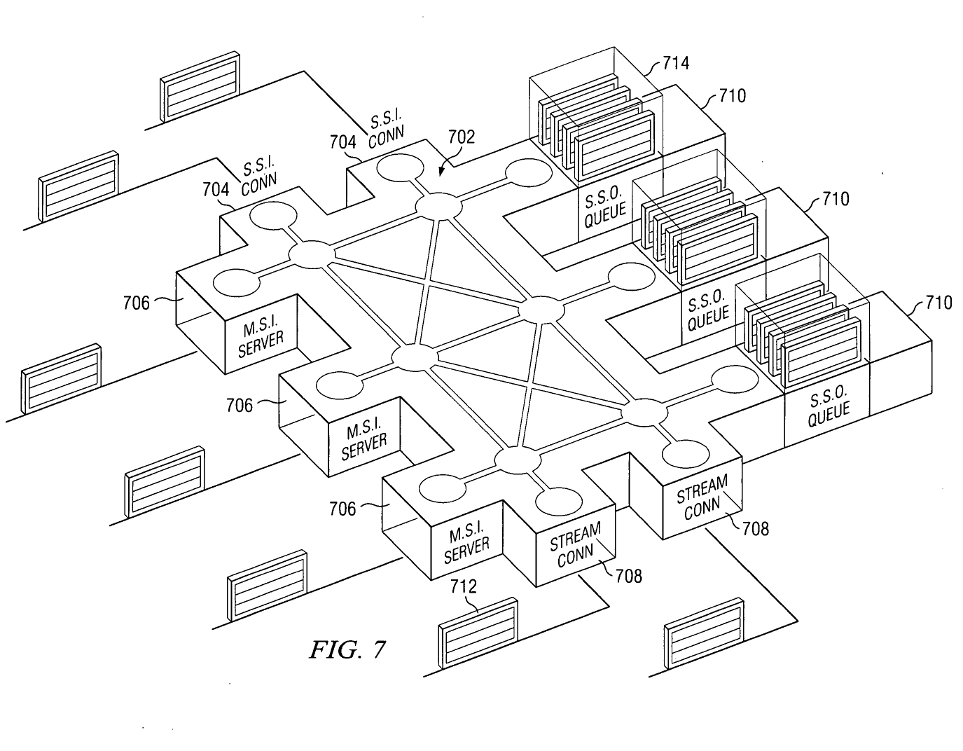

The second component in the multi-level firewall operates at the socket level. The Control Logic Firewall is interested in data; where as the Socket Firewall is interested in connection points. FIG. 7 depicts the MIOSE with multiple connection points.

FIG. 7 represents an agent with two SSI connections (704), three MSI servers (706), two file streams (708) and three SSO connections (710) with corresponding queues (714). Tickets (712) arrive from the various connections are intercepted by the MIOSE (702), tested for validity, filtered and potentially routed locally or to remotely connected peers. Any number of configurations is possible including up to 256 simultaneous connections. This is however limited by the system resources upon which the agent resides.

The Socket Control Matrix provides for maximum control of tickets traveling though the transport system. Modifications to the configuration file determine the identity of the Matrix. Any number of profiles can be used to create a variety of architectures for interconnectivity of system devices.

Security Module

The Security Module (308) is different than the other modules in that it utilizes existing industry available solutions. This area has been proposed and scrutinized by the industries experts and been documented in countless RFC's. The transport system operates above the network layer and can take advantage of existing solutions implemented such as IP SECURITY (IPSEC). Implementing cryptographic libraries allows for session level security such as Secure Socket Layer (SSL), and Transport Layer Security (TLS). Tickets can be digitally signed by the internal MD5 and SHA1 functions for integrity. Some tickets require a higher level of authorization which requires certificate generation and authentication routines.

Connectivity Architectures

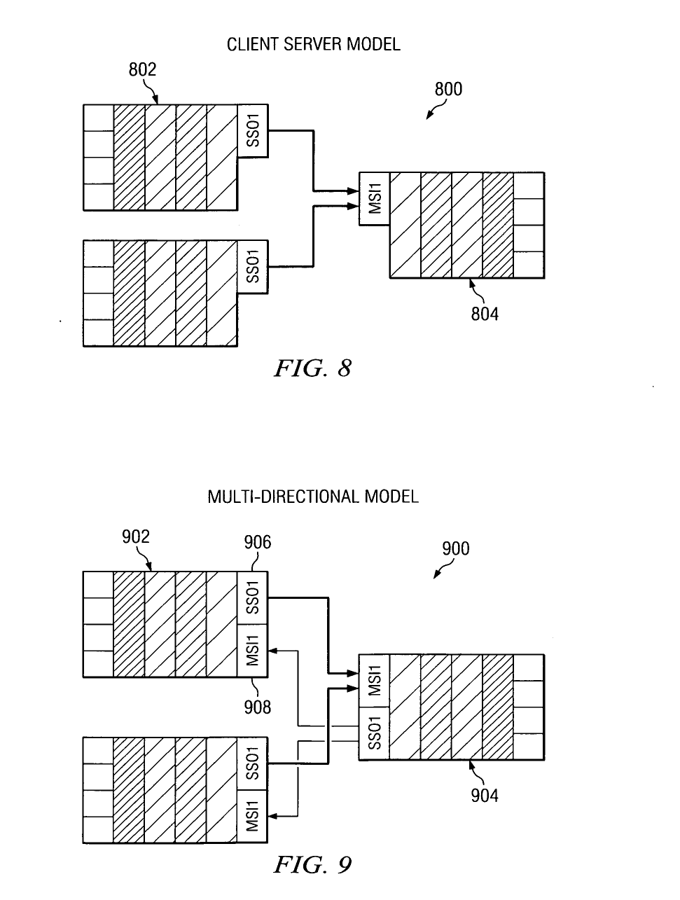

Clients in the present embodiment initiate connections through a local SSO connection to a remote MSI server. This follows a typical client-server module. As with most client-server models data is requested from the server and then sent to the client. In the instant architecture of the present invention, tickets are sent upstream to the server. This generic building block of the system is depicted in FIG. 8.

In the client-server model (800), the client (802) initiates all transactions. The server (804) sends data to the client (802), but only in response to the client's transaction. One reasons for this is the randomness of the client sending its requests. If, by chance, both the server and client were to send requests at the same time, data corruption would occur. Both sides would successfully send their requests but the responses they would receive would be each other's requests.

The present invention is designed to interconnect agents to provided component-to-component connectivity using the multi-directional model (900) as depicted in FIG. 9. By providing dual connections to each agent (900), transmissions can be initiated in both directions allowing multi-directional ticket flow. Each agent has SSO and MSI connections available. A first agent (902) establishes an SSO connection (906) to a second agent (904) via the second agent's MSI pool. The second agent (904) establishes an SSO connection with the first agent's MSI pool (908). Thus, true multi-directional communications can take place between the first and second agent without the fear of data corruption due to overwriting tickets as previously mentioned.

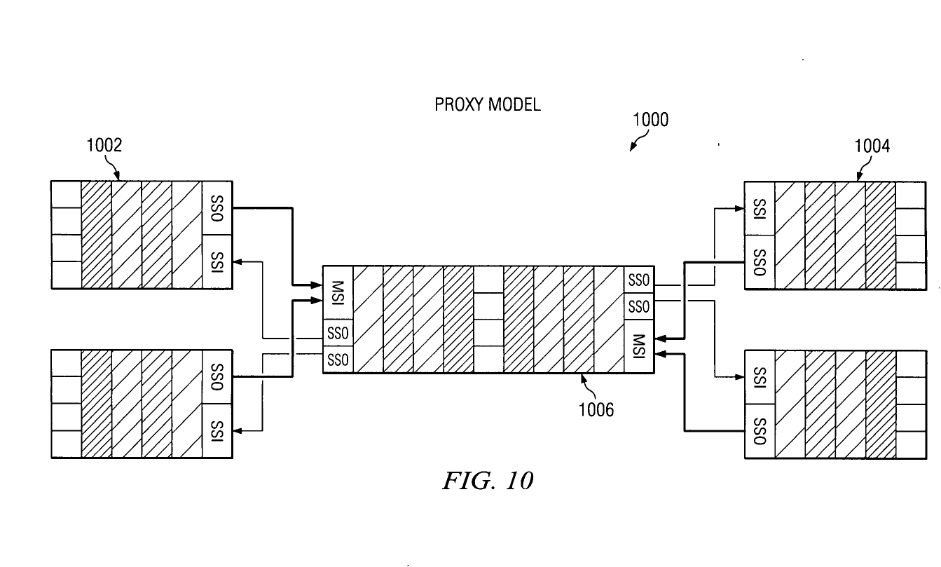

FIG. 10 depicts an embodiment of a proxy model (1000). The proxy model (1000) allows agents to be interconnected via a relay function. Agents send tickets to other agents, who then forward the ticket to the destination or the next relay in its path. Each agent has an integrated relaying functionality that can be controlled by the firewalls within the Socket Control Matrix. For example, a first agent (1002) communicates with a second agent (1004) through a proxy agent (1006).

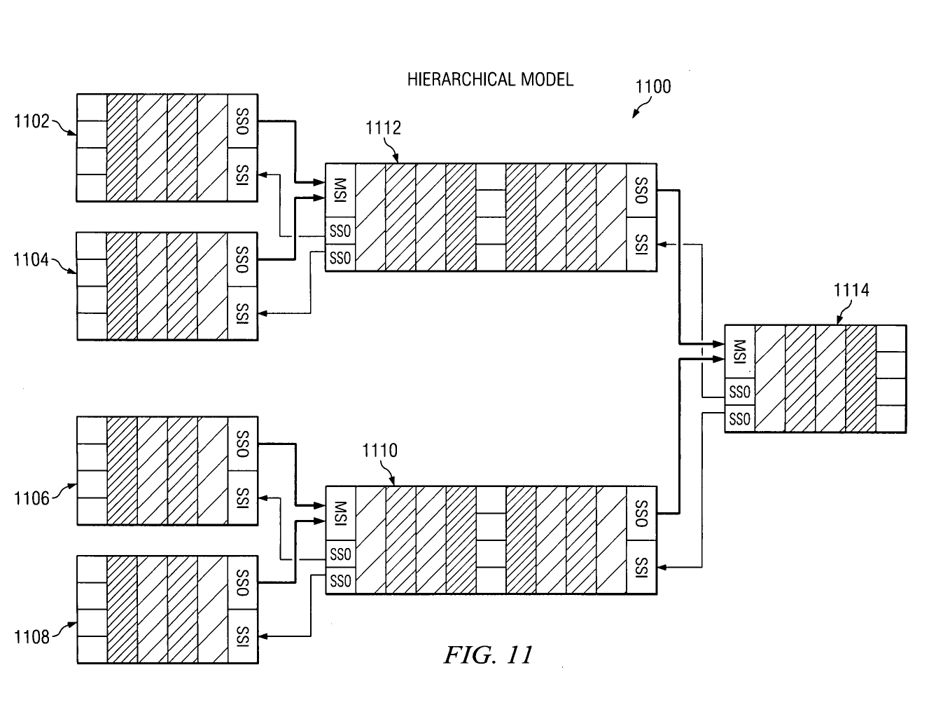

FIG. 11 depicts an embodiment of a hierarchical model (1100). The hierarchical model (1100) extends the proxy model (1000) by creating multiple groups of agents. This model is commonly used in event correlation when network data needs to be sent to a single agent for analysis. For example, the network depicted in FIG. 11 features a correlation agent (1114). This agent accumulates log activity from each of the area agents and correlates the activity to determine if suspicious activity is occurring on the network (such as a system hack or transmission virus. Log activity from the first agent (1102) and second agent (1104) pass through their connected proxy agent (1112), while log activity from the third agent (1106) and fourth agent (1108) pass through their connected proxy agent (1110). Each proxy then passes the log data to the correlating agent (1114). The correlating agent (114) reconstructs network activity by correlating events in each log file. An analysis can then be performed on the reconstructed network activity to determine if suspicious events have occurred, such as a computer virus that hijacks an agent and forces it to send spam messages.

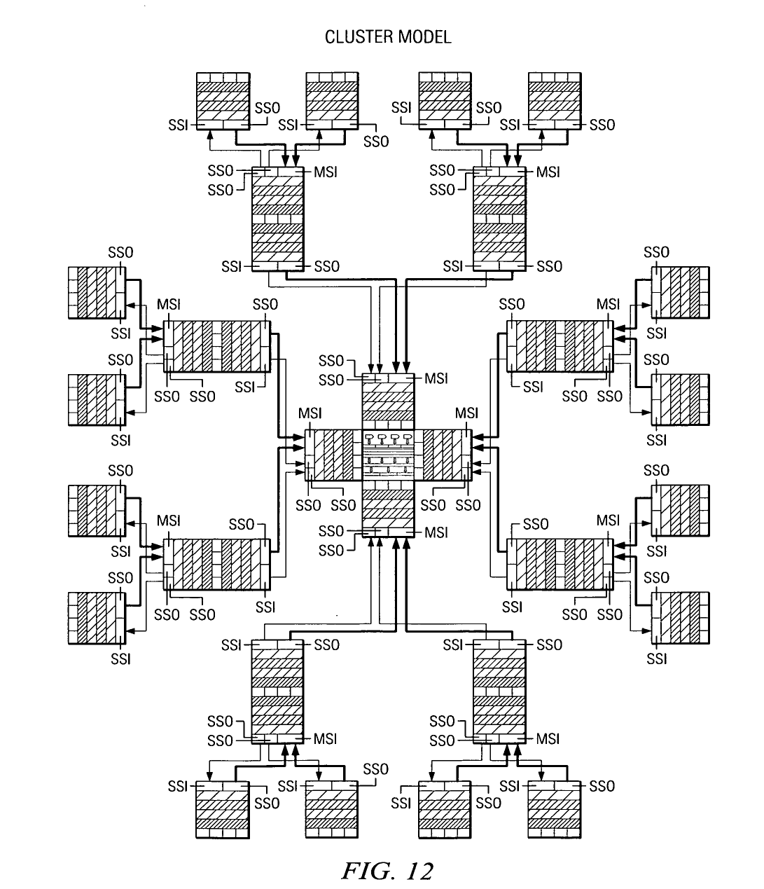

FIG. 12 depicts an embodiment of a cluster model (1200). The cluster model joins 2 or more hierarchical models (1100) to create a community of agents. Clusters may be interconnected with other clusters, thereby creating, in essence, and endless system of agents.

Rules of Connectivity

System agents in the present embodiment are designed to only communicate with like agents. This is considered Active Connectivity. However, agents can also be configured to accept connections from passive monitor device, such as devices that use SNMP and Syslog redirection.

Each agent initiates connectivity to its upstream neighbor(s) to a predetermined IP address and port number unless there is no upstream agent (a.k.a. “STUB”). Each agent also accepts connections from downstream neighbors, but will do so only if the client meets certain security criteria.

In the event of a communication error to an upstream neighbor or neighbors, an agent may enter into a beacon state where upstream connectivity is terminated and reestablished or bypassed if a connection is not possible.

Each agent in this embodiment is responsible for sending CONTROL_ECHO tickets to the upstream neighbor or neighbors at a pre-determined interval to ensure a constant state of connectivity. This is often necessary as data may not be sent for a period of time. The CONTROL_ECHO ticket is sent on a configurable interval to keep the session alive (i.e., heartbeat pulse). In the event that transaction data or systems events are sent, such heartbeats are suppressed to conserve bandwidth and system resources.

If an agent with downstream neighbors does not receive “ANY” data from that agent for a pre-determined time that agent is assumed to have “timed-out”. In this event, the upstream agent will either generate an ESM_MESSAGE that the downstream Agent TIMED-OUT and send it to its upstream neighbor(s), or terminate the connection altogether.

Each agent in this embodiment must generate an ESM Message to their upstream neighbor(s) in the event of a change in connectivity to their downstream neighbor or neighbors. This change in connectivity occurs when a connection was created, a connection was terminated, a connection went in to backup mode, or a functionality or security event occurred with the agent. If an agent has no upstream neighbor, then it is assumed the agent is upstream. Likewise, if an agent has no downstream neighbor then it is assumed the agent is downstream.

Agent Functions

Each agent's functionality is determined by its unique configuration file. Agents may be chained together to create a powerful distributed network of machines that, overall, can perform a multitude of tasks.

FIG. 13 depicts the modularity of a typical system agent (1300). The main component of the Agent is the Control Center (1302). The Control Center (1302), the core of the agent, performs the following tasks: read the configuration file; verify the validity of configuration file; verify the license and usage of agent; and initialize, de-initialize, and update the system and personality modules. Upon Agent startup, the Control Center reads the configuration file, verifies it, then loads, validates and initializes all system modules. Any personality modules are loaded and initialized next to complete the startup sequence. In the event a module needs to be updated, patched, or newly added, the Control Center, upon validation, accepts the system transaction and repairs, replaces or adds the new module.

Agent Configuration File

Upon Agent startup, the Control Center searches for the configuration file. In the present embodiment, the configuration file is formatted as XML tagged data. However, one skilled in the art will appreciate that any machine readable format is acceptable and within the scope of the present invention.

The configuration file consists of, among others, templates for Base, System and Personality Modules. Base templates are common to all agents. An example is as follows:

```
# Configuration template for all device entities
<SYSTEMCONFIG>
    <CONTROL></CONTROL>
    <MODULES></MODULES>
    <LOOPTIMEOUT></LOOPTIMEOUT>
    <TIMESYNC></TIMESYNC>
    <TIMEOUTFUDGEFACTOR></TIMEOUTFUDGEFACTOR>
    <BEACON>
        <BEACONINTERVAL></BEACONINTERVAL>
        <BEACONDURATION></BEACONDURATION>
    </BEACON>
</SYSTEMCONFIG>
# Master template used in all XML transmissions
<SYSBASE><?xml version=‘1.0’ encoding=‘ascii’?>
    <HEADER>
        <INFO>
            <ENTITYINFO>
                <ENTITY></ENTITY>
                <DEVICE></DEVICE>
                <GROUP></GROUP>
            </ENTITYINFO>
            <SYSTEM>
                <HOST>
                    <NAME></NAME>
                    <IP></IP>
                </HOST>
            </SYSTEM>
            <CONTEXT></CONTEXT>
            <MODULE></MODULE>
            <MODKEY></MODKEY>
        <INFO>
        <TRANSPORT>
            <DEVICEPATH></DEVICEPATH>
            <UTC>
                <START></START>
                <END></END>
                <OFFSET><IOFFSET>
                <DEVIATION></DEVIATION>
            </UTC>
        </TRANSPORT>
        <MODULEDETAIL></MODULEDETAIL>
    </HEADER>
</SYSBASE>
# -----SYS Messages----
<SYSMESSAGE>
    <CONFIG>
        <NAME>SYSMESSAGE</NAME>
        <TYPE>STREAM</TYPE>
        <DELlM>;</DELlM>
        <GROUP>POLARIS</GROUP>
        <INPUT>.Isstep.msg</INPUT>
        <OUTPUT>SSO1</OUTPUT>
    </CONFIG>
    <LOG>
        <HASH></HASH>
        <DATE></DATE>
        <TIME></TIME>
        <CODE></CODE>
        <MESSAGE></MESSAGE>
    </LOG>
</SYSMESSAGE>
```

The <SYSTEMCONFIG> template is common to all agents in the present embodiment. The <SYSBASE> and <SYSMESSGES> templates each supports a specific application but contains certain fields that apply to all agents in general.

To allow this type of system to work in essentially any network topology, each agent is configured with basic parameters, such as a Device ID (DID), and Entity ID (EID) and a Group ID (GID).

The DID is a unique alphanumeric code that identifies the agent. The DID is important because all TCP/IP based devices are assigned two identification tags in order to communicate: A physical address known as the MAC address and the network address or IP address. These address (physical and MAC) work fine and could be used as the Device ID. However, by Internet networking standards machines are allowed to use private addressing schemes for security reasons or if there not connected to the public Internet and want to use TCP/IP. The IANA has set aside three subnets for this use. Class A. 192.168.1-255.0; Class B. 172.16.16-32.0; and Class A. 10.0.0.0. Devices intending to use this addressing scheme and needing to connect to the Internet were allowed if those addresses were translated to publicly assigned address before routing to the Internet (i.e., address translation). Firewalls or other such devices that translate or hide the physical address to a publicly addressable address typically perform such translation.

However, such addressing creates some problems. First, some applications embed the physical address into the data portion of the packet. Most translating devices are not aware or capable of such translations and communication problems occur. The present invention is aware that some devices may have two different addresses. Therefore, upon initialization of the agent, the local IP address is obtained from the OS and utilized. When an upstream neighbor accepts a connection from a downstream neighbor, the IP address used to create the socket is also utilized. Any translation preformed will be realized from the socket address. Second, since anyone is able to use the IANA addressing scheme it is possible that multiple networks—even networks in the same company—can share an address. The DID can therefore be used to identify agents in order to eliminate this confusion.

In the present embodiment, two types of DIDs exist:

```
TYPE 1 Device ID
10001-01000001-00-01
vvvvv----EID (any digit 0-9 A-F) (1,048,576 Entities)
      vv------Iocation identifier (OO-FF)
        vv------unused
          vvvv--------device number (1-9999)
              vv-------moduleJd (see below)
                  vv-----instance (01-99)
10001-01000001-00-01
TYPE 2 Device ID
1-1000-01000101-00-01
v---------PID provider id (O-F)
  vvvv----EID Entity ID(any digit 0-9 A-F) (65536 Entities)
        vv------Iocation identifier (OO-FF)
          vvvv--------device number (1 -9999)
            vv------device instance(01-99)
                vv--------module_id (see below)
                    vv-----module instance (01-99)
1-1000-01000101-00-01
```

The primary difference between the above DIDs is that Type II DIDs are designed for use in a provider environment. Examples include a service monitoring company or a hosting environment.

The EID is a unique alphanumeric code that identifies which entity the agent belongs to. This element is used for greater control and identification. The EID is a unique software identifier that exists for each agent, and is used to allow agents to identify associated peers and information sent to them.

The GID is a unique alphanumeric code that identifies which group the agent belongs to. This element is primarily used for grouping agents. This GID also allows specific path creation, bulk data transfers, and complete system updates such as time. Multiple groups can be concatenated for extended control.

The specific instructions necessary to utilize the present invention reside in task specific groups called Modules. Each module is designed to operate independently and is linked with other modules as building blocks to create greater functionality. For example, there are system modules, which contain the core building block necessary for system initialization, data transport and manipulation, and personality modules, which are used to carry out agent specific tasks.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. An agent module operable on a first networked computing device, the agent module for providing multi-directional data communications between the first networked computing device and one or more other networked computing devices, the agent module comprising:
a control logic (CL) module for creating and processing ticket structures, wherein each ticket structure contains source agent module and destination agent module specific fields; and
an input output (IO) module for the creation and handling of network socket connections with other like-modules, wherein the IO module comprises one or more outbound network sockets and a plurality of inbound network sockets, and wherein the IO module is capable of simultaneously supporting at least one inbound network socket connection from another agent module operable on a second networked computing device and at least one outbound network socket connection to the another agent module on the second networked computing device.

2. The agent module of claim 1, the ticket structure further comprising a payload data field, wherein the ticket structure is utilized for passing data transaction information or system event information between socket-connected agent modules, and wherein the agent module is capable of managing simultaneous reception and transmission of ticket structures over the inbound and outbound network socket connections, respectively.

3. The agent module of claim 2, the agent module further comprising at least one data transaction ticket queue for serial processing of inbound or outbound data transaction tickets.

4. The agent module of claim 3, wherein the data transaction ticket queue preserves tickets during periods of socket connectivity problems between connected agent modules.

5. The agent module of claim 3, wherein the data transaction ticket comprises a delay field and wherein the CL module allows for delaying of the transmission of the respective data transaction ticket based upon the delay field entry.

6. The agent module of claim 2, the agent module further comprising at least one system event ticket queue for serial processing of inbound or outbound system event transaction tickets.

7. The agent module of claim 6, wherein the system event queue preserves tickets during periods of connectivity problems between connected agent modules.

8. The agent module of claim 6, wherein a system event ticket representing a recurring system event is maintained within the system event queue as a static entry to allow for reuse of the system event ticket.

9. The agent module of claim 6, wherein the system event ticket comprises a time field and wherein the CL module allows for scheduling of the respective system event based upon the time field entry.

10. The agent module of claim 6, wherein the system event ticket comprises a delay field and wherein the CL module allows for delaying of the transmission of the respective system event ticket based upon the delay field entry.

11. The agent module of claim 1 wherein the CL module is integrated within a layer of the host computer's OSI model stack.

12. The agent module of claim 1 wherein the IO module is dynamically configurable during operation to control the types of connections allowed and maintained between remote networked agent modules.

13. The agent module of claim 1, the agent module further comprising a data module, wherein the data module is capable of converting data transaction ticket payload data to and from at least one industry standard data format.

14. The agent module of claim 1 wherein the IO module is capable of inbound file stream or outbound file stream socket connections.

15. The agent module of claim 1 wherein the IO module is capable of single-socket inbound or single-socket outbound socket connections.

16. The agent module of claim 1 wherein the IO module is capable of multi-socket inbound socket connections.

17. The agent module of claim 1 wherein the IO module is capable of inbound interprocess or outbound interprocess socket connections.

18. The agent module of claim 1 wherein the IO module utilizes beaconing to monitor socket connection states with connected upstream agent modules, and wherein the IO module provides a backup socket connection for use when a primary socket connection is lost.

19. The agent module of claim 18 wherein the IO module is operable in a primary mode that monitors a primary socket connection and automatically switches to and maintains a backup socket connection upon failure of the primary socket connection.

20. The agent module of claim 18 wherein the IO module is operable in a primary plus connection mode that monitors a primary socket connection and automatically switches to a backup socket connection until the primary socket connection is restored.

21. A method for providing multi-directional data communications between a plurality of networked computing devices, the method steps comprising:
providing a first agent module operable on a first computing device and a second agent module operable on a second computing device networked with the first computing device, wherein each agent module comprises:
a control logic (CL) module for creating and processing ticket structures, wherein each ticket structure contains source agent module and destination agent module specific fields; and
an input output (IO) module for the creation and handling of network socket connections with other agent modules, wherein the IO module comprises one or more outbound network sockets and a plurality of inbound network sockets, and wherein the IO module is capable of simultaneously supporting at least one inbound network socket connection from a second module and at least one outbound network socket connection to the second module;
establishing an outbound socket connection from the first agent module to the second agent module;
establishing an outbound socket connection from the second agent module to the first agent module; and
transmitting ticket structures from the first agent module to the second agent module while simultaneously transmitting ticket structures from the second agent module to the first agent module.

22. The method of claim 21, the ticket structure further comprising a payload data field, wherein the ticket structure is utilized for passing data transaction information or system event information between the connected first and second agent modules, and wherein each agent module is capable of managing simultaneous reception and transmission of ticket structures over its inbound and outbound network socket connections, respectively.

23. The method of claim 22, the method steps further comprising:
providing a data transaction ticket queue to allow for serial processing of inbound or outbound data transaction tickets.

24. The method of claim 23, the method steps further comprising:
preserving the data transaction tickets in the data transaction ticket queue during periods of connectivity problems between the first and second agent modules.

25. The method of claim 23, wherein the data transaction ticket comprises a delay field and wherein the CL module allows for delaying of the transmission of the respective data transaction ticket based upon the delay field entry.

26. The method of claim 22, the method steps further comprising:
providing a system event ticket queue for serial processing of inbound or outbound system event transaction tickets.

27. The method of claim 26, the method steps further comprising:
preserving the system event tickets in the system event ticket queue during periods of connectivity problems between the first and second agent modules.

28. The method of claim 26, the method steps further comprising:
maintaining a system event ticket in the system event queue to allow for reuse of the system event ticket for a specific recurring system event.

29. The method of claim 26, wherein the system ticket structure comprises a time field, the method steps further comprising:
scheduling a system event based upon the system ticket time field entry.

30. The method of claim 26, wherein the system ticket structure comprises a delay field, the method steps further comprising:
delaying the transmission of the respective system event ticket based upon the delay field entry.

31. The method of claim 21 wherein each agent's CL module is integrated within a layer of the host computer's OSI model stack.

32. The method of claim 21, the method steps further comprising:
dynamically configuring the types of connections allowed and maintained by the IO module.

33. The method of claim 22, the method steps further comprising:
converting the data transaction ticket payload data to and from an industry standard data format.

34. The method of claim 21, the method steps further providing:
providing inbound file stream or outbound file stream socket connections.

35. The method of claim 21, the method steps further providing:
providing single-socket inbound or single-socket outbound socket connections.

36. The method of claim 21, the method steps further comprising:
providing multi-socket inbound socket connections.

37. The method of claim 21, the method steps further comprising:
providing inbound interprocess or outbound interprocess socket connections.

38. The method of claim 21, the method steps further comprising:
utilizing beaconing to monitor socket connection states with connected upstream agent modules, and
providing a backup socket connection for use when a primary socket connection is lost.

39. The method of claim 38, the method steps further comprising:
operating in a primary connection mode by monitoring a primary socket connection and automatically switching to and maintaining a backup socket connection upon failure of the primary.

40. The method of claim 38, the method steps further comprising:
operating in a primary plus connection mode by monitoring a primary socket connection and automatically switching to a backup socket connection until the primary socket connection is restored.

41. The method of claim 21, wherein the ticket structure further comprises an offset field, the method steps further comprising:
utilizing the offset field to establish a time offset value that reflects the data transmission latency between two distant agents; and
performing time synchronization between the distant agents.
